(19) United States
(12) Patent Application Publication
(10) Pub. No.: US 2009/0303072 A1
(43) Pub. Date: Dec. 10, 2009

(54) MULTI-USE LIGHT INDICATORS

(75) Inventors: Erik Gilling, San Francisco, CA (US); Moshen Chan, San Francisco, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/134,167

(22) Filed: Jun. 5, 2008

(51) Int. Cl. G09F 9/33; G08B 5/00

(52) U.S. Cl. 340/815.45; 340/815.4

(57) ABSTRACT

An approach involving light use for multiple purposes in a portable computing device is disclosed. In one embodiment, a method can include: programming a visual state information indicator in a portable computing device; mapping the visual state information indicator to a light source and a parameter of a device module; receiving a monitoring signal from the device module, where the monitoring signal conveys a state of the parameter in real-time; and adjusting the light source in response to a comparison of the monitoring signal against the programmed visual state information indicator.

### CROSS-REFERENCE TO RELATED APPLICATION

This application is related to co-pending U.S. patent application Ser. No. ______, filed on Jun. 5, 2008 entitled “USER CONFIGURATION FOR MULTI-USE LIGHT INDICATORS” (Attorney Docket No. 100127-002400US) which is hereby incorporated by reference as if set forth in this application in full for all purposes.

### FIELD OF THE INVENTION

The invention relates in general to portable computing devices, and more specifically to multi-use light indicators in portable computing devices.

### BACKGROUND

Increasing use of portable computing or electronic devices has led to increased customization opportunities based on user preferences. Devices such as cell phones, personal digital assistants (PDAs), small computers, e-mail devices, audio players, video players, etc., are complex devices often having many functions and subsystems. Tracking and effectively conveying status information for the many functions and subsystems is often difficult.

In addition, display screen sizes are typically made relatively small in such portable computing devices. Accordingly, conventional means of conveying status or other information about the inner functions and subsystems of such portable computing devices may not be most suitable for some applications.

### SUMMARY

A multi-use light indicator approach in accordance with embodiments of the present invention can be utilized to convey information about a status or condition of one or more modules within a portable computing device. Further, a user can program specific light (e.g., light emitting diode (LED)) visual state information indications or patterns, and link them to particular modules for monitoring. In this fashion, a user can personalize the multi-use light display for a portable computing device.

In one embodiment, a method can include: programming a visual state information indicator in a portable computing device; mapping the visual state information indicator to a light source and a parameter of a device module; receiving a monitoring signal from the device module, where the monitoring signal conveys a state of the parameter in real-time; and adjusting the light source in response to a comparison of the monitoring signal against the programmed visual state information indicator.

In one embodiment, an apparatus can include: a controller configured to store a programmed visual state information indicator, a mapping of the programmed visual state information indicator to a selected light source, and a parameter of a device module in a portable computing device; a device monitoring inputs compare unit configured to receive a monitoring signal from the device module, and to provide a control signal to a light source operator in response to a comparison of the monitoring signal against the programmed visual state information indicator, where the monitoring signal conveys a state of the parameter in real-time; and a plurality of light sources coupled to the light source operator, and configured to display a real-time light indication in response to the control signal.

In one embodiment, a portable computing device can include: one or more processors; and logic encoded in one or more tangible media for execution by the one or more processors, and when executed operable to: program a visual state information indicator in the portable computing device; map the visual state information indicator to a light source and a parameter of a device module; receive a monitoring signal from the device module, where the monitoring signal conveys a state of the parameter in real-time; and adjust the light source in response to a comparison of the monitoring signal against the programmed visual state information indicator.

### BRIEF DESCRIPTION OF THE DRAWINGS

FIG. 1 illustrates an example portable computing device arrangement in accordance with embodiments of the present invention.

FIG. 2 shows an example LED controller structure in accordance with embodiments of the present invention.

FIG. 3 shows an example LED arrangement within a keyboard structure in accordance with embodiments of the present invention.

FIG. 4 shows an example user interface screen for LED pattern programming in accordance with embodiments of the present invention.

FIG. 5 illustrates a flow diagram of an example method of controlling multi-use LEDs in accordance with embodiments of the present invention.

### DETAILED DESCRIPTION

A multi-use light indicator approach in certain embodiments can be utilized to convey information about a parameter state (e.g., a status or condition) of one or more modules within a portable computing device. Further, a user can program specific light (e.g., light emitting diode (LED)) visual state information indications or patterns, and link them to particular modules for monitoring. In this fashion, a user can personalize the multi-use light display for a portable computing device.

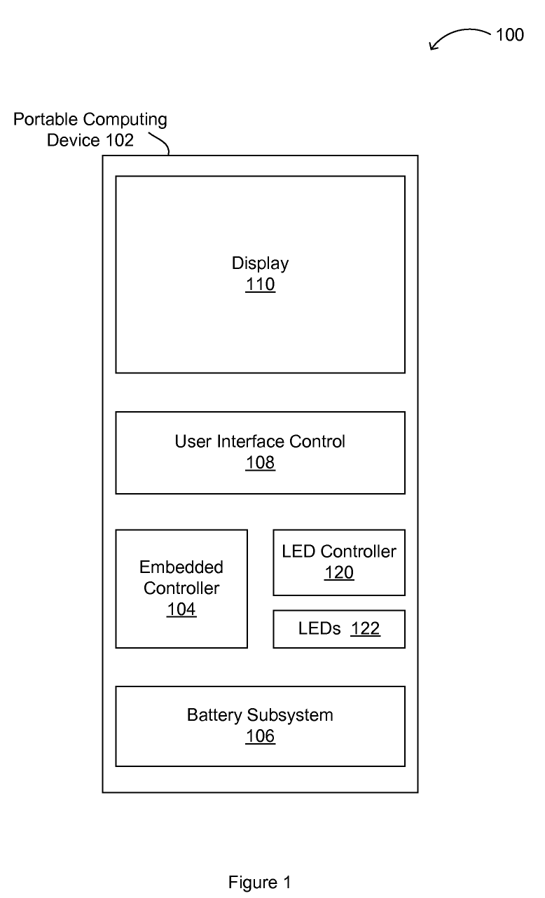

Referring now to FIG. 1, an example portable computing device arrangement in accordance with embodiments of the present invention is indicated by the general reference character 100. Portable computing device 102 can include embedded controller 104 (e.g., one or more processors), battery subsystem 106, user interface control 108, and display 110, for example. Battery subsystem 106 can primarily include batteries, but may also include any other suitable type of energy-providing mechanisms, such as capacitors and/or any suitable combination of capacitors and batteries.

Also, some features described herein may be adaptable to any type of power or light source, such as where an external battery or light is used (e.g., a device obtaining power from a vehicle's battery), or where a standard line power is used (e.g., alternating current residential or business infrastructure power). Further, battery subsystems or modules can include or be associated with unique identifiers (IDs), or nonvolatile storage elements (e.g., electrically erasable programmable read-only memory (EEPROM)) to save power management preferences.

In particular embodiments, LED controller 120 can be utilized to encode LED visual state indicators or patterns for control of LEDs 122. For example, a user interface or control can receive user preference inputs, such as for designating that certain LEDs flash, emit a certain color, have a designated intensity, an activation time interval, a gradient of LED colors, and/or an on/off duty cycle, as related to any particular module or device operation (e.g., via a parameter thereof). Thus, each module can interface with LED controller 120 to convey relevant information for monitoring that particular module. For example, battery subsystem 106 can convey charge status to LED controller 120, which may result in certain functions or light indications seen in LEDs 122.

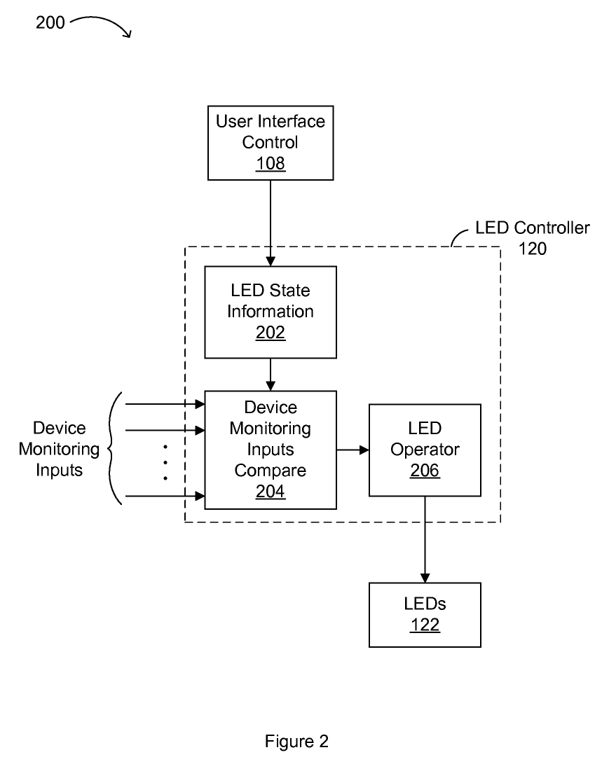

Referring now to FIG. 2, an example LED controller structure in accordance with embodiments of the present invention is shown and indicated by the general reference character 200. LED controller 120 can include LED state information 202 for receiving (e.g., via user interface control 108) and storing predetermined LED visual state information indications. In this fashion, LEDs can be user configurable for multiple uses. For example, LEDs in particular embodiments can be configured to display various indications, such as color, intensity, and duty cycle (e.g., on/off condition), and linked or mapped to any module, parameter, condition, or “state” amenable to monitoring (e.g., via a monitoring signal). Thus, such visual indications can be used for conveying multiple pieces of information via a single LED housing (e.g., one capable of emitting multiple colors, intensities, patterns, etc., from a single housing).

Device monitoring inputs compare 204 can receive device monitoring inputs from modules (e.g., battery subsystem 106, embedded controller 104, accelerometers, phone operation control, e-mail control, etc.) in the portable computing device. LED state information 202 can also provide input to device monitoring inputs compare 204 so that the particular modules and/or operations of which the user is concerned or wishes to have the LEDs indicate can be accommodated. LED operator 206 can receive input from device monitoring inputs compare 204, and may use this information to drive LEDs 122. Further, device monitoring inputs can convey a state of a module parameter in real-time.

In certain embodiments, user interface control 108 can be used to convey the selection of different modules, functions, conditions, etc., for different operations of LEDs 122. For example, a power LED off/on indication can be changed to red if the portable computing device is dropped. For determining when the device is dropped, one or more accelerometers embedded within the device can be accessed. A user may then want to check the integrity of the device's disk drive, or otherwise inspect the device for damage, prior to restoring power to the device.

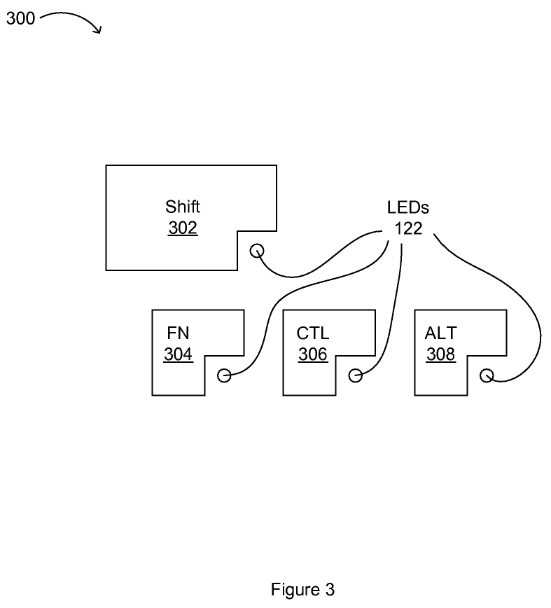

Referring now to FIG. 3, an example LED arrangement within a keyboard structure in accordance with embodiments of the present invention is shown and indicated by the general reference character 300. In this particular example, LEDs 122 can be embedded within a keyboard structure. As shown, shift key 302 can be arranged to reveal an LED 122. Similarly, function (FN) key 304, control (CTL) key 306, and alternate (ALT) key 308 can also be arranged to reveal LEDs 122. In this fashion, multi-use LEDs can be embedded within a keyboard structure to accommodate viewing by a user. Further, while some LEDs can be located within the keypad, others (e.g., those related to battery charge indications) can be located separately (e.g., on a side of portable computing device 102).

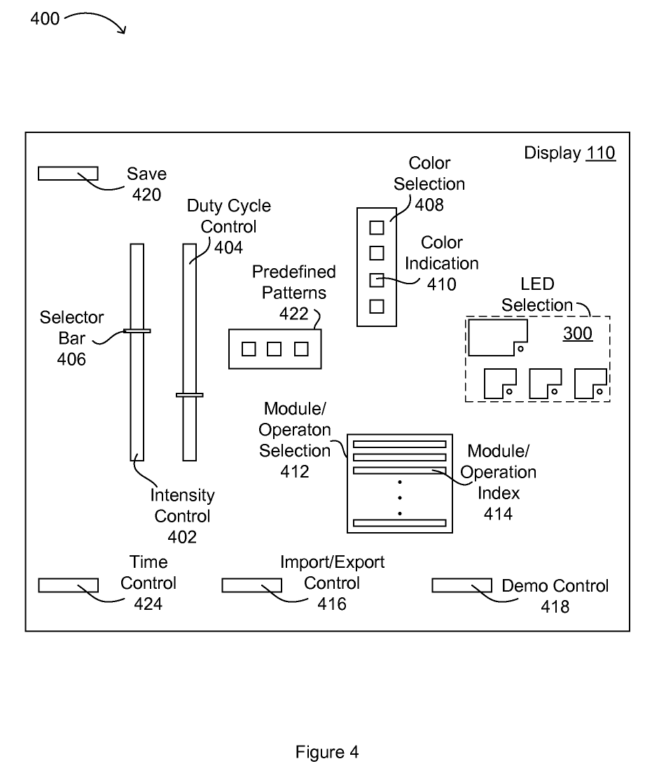

Referring now to FIG. 4, an example user interface screen for LED pattern programming in accordance with embodiments of the present invention is shown and indicated by the general reference character 400. Display screen 110 can show a plurality of touch-based (e.g., touch-sensitive), or other such user interface controls, for programming LED visual indications corresponding to particular module operations/conditions or states within the portable computing device. For example, an LED light intensity can be selected using intensity control 402 and selector bar or slider 406. Also, duty cycle control 404 can be used to select a particular LED on/off duty cycle, such as for a flashing pulse. Time control 424 can provide a time limit on any enabled setting, such as for a change from one color to another.

Further, a user can select from among a group of default or predefined patterns 422. For example, each button in predefined patterns 422 can represent a certain default pattern, which can be viewed by utilizing demo control 418. Also, while only three buttons are shown in predefined patterns 422, any suitable number of patterns and/or controls can be accommodated in particular embodiments. Also in particular embodiments, LED color selection 408 can be utilized with individual color indications 410 for choosing a particular color associated with a particular LED or other suitable type of light generator. To accommodate such color selection, different LEDs may be housed in a common casing and multiplexed or otherwise combined for choosing an appropriate color. Alternatives to button controlled LED color selection include color wheels. Also, any suitable number of colors may be accommodated in certain embodiments.

To choose which programmed LED pattern goes with which particular LED/light on the portable computing device, LED selection can include a representation of the keypad arrangement 300. For example, either the LED itself, the representation of the key arranged around a particular LED (e.g., shift key 302, FN key 304, CTL key 306, or ALT key 308), or the LED representation 300 on display 110, can be touched to designate a particular LED corresponding to the current LED programming. To select a module or operation to link to a selected LED and pattern, selection controls 412 having modules/operation indices 414 can be utilized. Generally, module/operation index 414 can define a module, operation, mode, state, and/or condition that can trigger an LED indication.

For example, a hibernate mode (e.g., selected via one of indices 414) can designate an LED pulsing that calls for a different color when the battery module for the portable computing device contains 50% or more of charge. The LED can change (e.g., when 80% or more of charge remains) to another color, such as white or green, or any suitable standard or predefined color. Then, a charge remaining range of from about 20% to about 50% would result in a yellow light color, while a battery charge of below 20% (e.g., hibernate mode) would result in a red pulsing light.

As another example, central processing unit (CPU) usage (e.g., expressed in percentage terms) can be linked to an intensity or changing light color when the CPU usage increases to over about 90%. Such an LED pattern can let the user know that there is something executing (e.g., in the background) on the CPU, so the user may be alerted to possibly take appropriate actions if the portable computing device is on limited battery supply. As another example, a user may want to program an LED to flash if there is an e-mail arriving in the user's in-box. Alternatively or in addition, such light indications can arise when a certain caller places a call for receipt via the portable computing device, or in general when a phone call is incoming.

Further, any rules or script-based programming language can be utilized to type or otherwise indicate such pattern control and linking to device modules or operations. Also, test or demo control button 418 can be used to demonstrate for the user any light colors, patterns, etc., programmed in the device. Also in certain embodiments, import/export control 416 can be utilized for patterns received from or destined for another location. For example, import/export control 416 can include a web site address for obtaining patterns, as well as default settings. The export function may be utilized to save the settings outside of the portable computing device or pattern definition application. In addition, save button 420 can be utilized to save patterns, etc., as programmed, within the portable computing device (e.g., in LED state information 202).

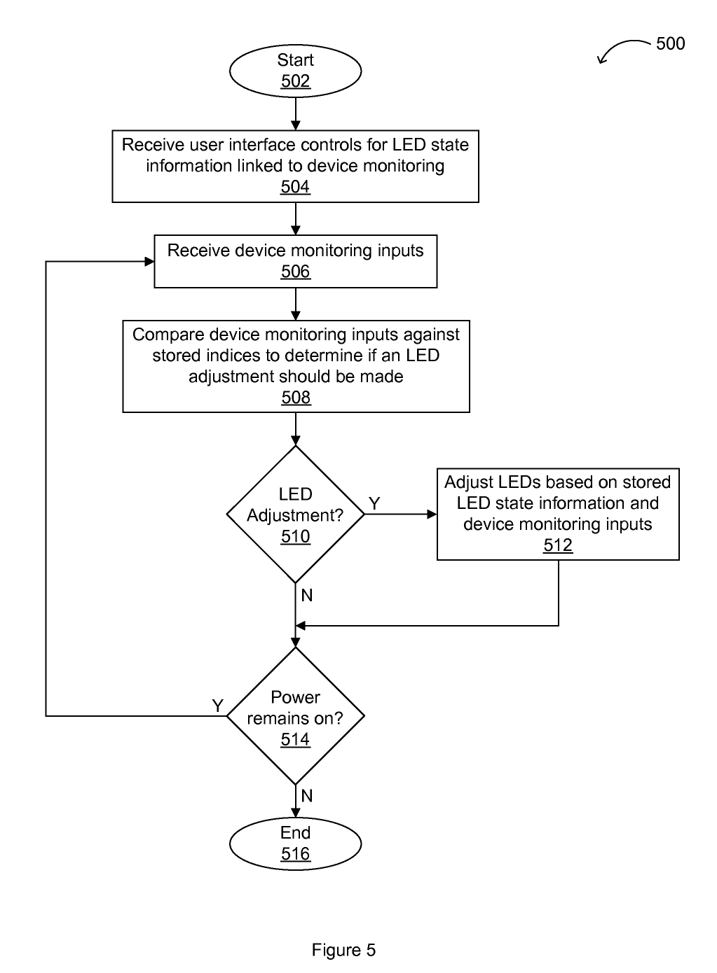

Referring now to FIG. 5, a flow diagram of an example method of controlling multi-use LEDs in accordance with embodiments of the present invention is shown and indicated by the general reference character 500. The flow can begin (502), and user interface controls for LED state information for visual indications linked to device monitoring can be received (504). For example, such state information can be input via the interface screen 400 discussed above. Once a user has defined state information for visual indications, and linked to corresponding device module operations, conditions, etc., the device can receive monitoring inputs (506).

The device monitoring inputs can then be compared against stored indices (e.g., predetermined parameter states) linked to the patterns or other indications to determine if an LED adjustment should be made (508). For example, a device monitoring input can include information about a status or condition of a particular module in the device (e.g., via a module parameter). If this status, condition, and/or module has an LED pattern programmed and linked thereto, the device monitoring inputs can convey this information for comparison (e.g., via a device monitoring inputs compare module 204), for subsequent control input to LED operator 206.

However, if a particular module or condition to be watched has not changed, no corresponding change to an associated LED may be warranted. Thus, if the comparison indicates that an LED adjustment should be made (510), the associated LED may be adjusted based on stored LED state information and the device monitoring inputs (512). For example, a different programmed LED pattern may be selected and applied, or another suitable adjustment can be made as appropriate for the associated LED. However, if no LED adjustment is warranted (510), the device monitoring inputs can continue to be received (506), so long as power to the device remains on (514), otherwise completing the flow (516).

Although particular embodiments of the invention have been described, variations of such embodiments are possible and are within the scope of the invention. For example, although light types and user interface controls have been described, other types of lights, user interfaces, and/or controls, can be accommodated in accordance with embodiments of the present invention. Also, applications other than portable computing devices or the like can also be accommodated in accordance with particular embodiments. Embodiments of the invention can operate among any one or more processes or entities including users, devices, functional systems, and/or combinations of hardware and software.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, “a particular embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. For example, distributed, networked systems, components and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method, comprising:
programming a visual state information indicator in a portable computing device;
mapping the visual state information indicator to a light source and a parameter of a device module;
receiving a monitoring signal from the device module, wherein the monitoring signal conveys a state of the parameter in real-time; and
adjusting the light source in response to a comparison of the monitoring signal against the programmed visual state information indicator.

2. The method of claim 1, wherein the mapping the visual state information indicator comprises selecting a module/operation index.

3. The method of claim 1, wherein the light source comprises a light emitting diode (LED).

4. The method of claim 1, wherein the monitoring signal comprises a battery charge indication.

5. The method of claim 1, wherein the monitoring signal comprises an incoming call indication.

6. The method of claim 1, wherein the monitoring signal comprises an e-mail received indication.

7. The method of claim 1, wherein the monitoring signal comprises a drop indication from an accelerometer module.

8. An apparatus, comprising: a controller configured to store a programmed visual state information indicator, a mapping of the programmed visual state information indicator to a selected light source, and a parameter of a device module in a portable computing device;
a device monitoring inputs compare unit configured to receive a monitoring signal from the device module, and to provide a control signal to a light source operator in response to a comparison of the monitoring signal against the programmed visual state information indicator, wherein the monitoring signal conveys a state of the parameter in real-time; and
a plurality of light sources coupled to the light source operator, and configured to display a real-time light indication in response to the control signal.

9. The apparatus of claim 8, wherein the state of the parameter comprises a mode, status, or condition of the device module.

10. The apparatus of claim 8, wherein the plurality of light sources comprise a light emitting diode (LED).

11. The apparatus of claim 8, wherein the plurality of light sources are configured within a keyboard structure of the portable computing device.

12. The apparatus of claim 11, wherein the keyboard structure comprises a plurality of keys arranged to accommodate the plurality of light sources.

13. The apparatus of claim 12, wherein the plurality of keys comprise a shift key, a function key, a control key, and an alternate key.

14. The apparatus of claim 8, wherein the monitoring signal comprises an incoming call indication.

15. The apparatus of claim 8, wherein the monitoring signal comprises an e-mail received indication.

16. The apparatus of claim 8, wherein the monitoring signal comprises a drop indication from an accelerometer module.

17. A portable computing device, comprising:
one or more processors; and
logic encoded in one or more tangible media for execution by the one or more processors, and when executed operable to:
program a visual state information indicator in the portable computing device;
map the visual state information indicator to a light source and a parameter of a device module;
receive a monitoring signal from the device module, wherein the monitoring signal conveys a state of the parameter in real-time; and
adjust the light source in response to a comparison of the monitoring signal against the programmed visual state information indicator.

18. The portable computing device of claim 17, wherein the one or more processors comprise an embedded controller.

19. The portable computing device of claim 17, wherein the light source comprises a light emitting diode (LED).

20. The portable computing device of claim 17, further comprising a keyboard structure having a plurality of keys arranged to accommodate a plurality of light sources.
